(19) United States
(12) Patent Application Publication
(10) Pub. No.: US 2017/0142914 A9
(43) Pub. Date: May 25, 2017

(54) Plant holder for attachment to a rod or a tube

(71) Applicant: Wilhelm MARKE, Sigmarzell (DE)

(72) Inventor: Wilhelm MARKE, Sigmarzell (DE)

(21) Appl. No.: 14/450,742

(22) Filed: Aug. 4, 2014

(30) Foreign Application Priority Data
Aug. 7, 2013 (DE) 20 2013 007 061

(51) Int. Cl. A01G 17/04

(52) U.S. Cl. CPC A01G 17/04

(57) ABSTRACT

A plant holder having an elongated base body several passages extending transversely to the base body for receiving wire-shaped fasteners for plants, and a clamping device disposed on one end of the base body for affixing the plant holder on a holder to be fastened in the floor or on a wall. The base body has latching protrusions associated with the passages for detachably fastening an end of the wire-shaped fastening means that is bent away and extends substantially parallel to the base body. The wire-shaped fastener for the plant can thus be easily and very rapidly attached to the base body and detached again, without requiring a tool or other resources. With the clamping device, the base body of the plant holder can be quickly attached to a rod or tube with a large holding force and just as easily detached again, also without the use of tools.

### BACKGROUND OF THE INVENTION

(1) Field of the Invention

The invention relates to a pant holder for attachment to a rod or tube, wherein the plant holder can be used to hold all kinds of plants, both indoors and outdoors. It is advantageous and important that a wire for supporting the plant can be easily, quickly and safely attached to the plant holder.

(2) Description of Related Art

A plant holder of the aforementioned type is known, for example, from EP 1815734 A2 by the same applicant. The plant holder is attached therein to a rod or a tube by a clamping block and a clamping screw. This type of attachment can have several drawbacks. On the one hand, the screw attachment is too slow to manipulate. On the other hand, the clamping screw is difficult to manipulate with garden gloves.

### BRIEF SUMMARY OF THE INVENTION

It is the object of the invention to propose a plant holder with an improved fastening device that can be quickly and easily attached to a rod or a tube. It is another object of the invention to construct the plant holder such that the wire for supporting the plant can be quickly and securely attached to the plant holder

According to a preferred embodiment of the invention, the plant holder includes an elongated base body having a plurality of passages that extend transversely to the base body and are configured to receive the wire-shaped fastening means for plants, and a clamping device that is arranged at one end of the base body for affixing the plant holder to a holder to be attached in the ground or on a wall.

According to the invention, the base body has locking projections associated with the passages for detachable attachment of an end of the wire-shaped fastening means that is bent off and extends substantially parallel to the base body.

The wire-shaped fastening means for the plant can thus be easily and quickly attached on the base body and detached again, without requiring a tool or other resources.

Furthermore, with the clamping device, the base body of the plant holder can be quickly attached to a rod or a tube with large holding force and just as easily detached again, also without using tools.

Preferred embodiments and other advantageous features of the plant holder are recited in the dependent claims.

Exemplary embodiments of the invention are illustrated in the drawings. Other features and advantages of the invention will be evident from the drawings and their description.

### BRIEF DESCRIPTION OF THE SEVERAL VIEWS OF THE DRAWING(S)

The drawings show in:

FIG. 1 the plant holder in perspective view from the top with an inserted wire;

FIG. 2 the plant holder in a perspective view from the bottom with a bent-over end of the wire;

FIG. 3 the plant holder, in a perspective view from the bottom with a bent-over and a clampingly held wire end.

### DETAILED DESCRIPTION OF THE INVENTION

The drawings show the plant holder according to the invention, substantially composed of an elongated base body 1 and a clamping device 2 which is disposed at one end of the base body 1.

The clamping device 2 is composed of two clamping jaws 3, 4 which are biased against each other by a spring force and can be clamped to a rod or tube (not shown) by means of a clamping screw 5. The clamping jaws grip around the rod (tube) and are pressed together with the clamping screw 5, so that they are clamped to the rod (tube). The clamping jaws 3, 4 are pivotally supported on a reinforced clamping block 6. Rods with a diameter of, for example, 8 mm to 28 mm can be clamped. The plant holders can be affixed at any desired position along the rod and detached again.

The base body 1 is preferably formed not of a solid material, but is instead formed with ribs and recesses in order to save material and thus weight without adversely affecting the rigidity. Passages 7-10 that extend transversely to the longitudinal direction of the base body for receiving the wire-shaped fastening means for plants are provided along the elongated base body 1. The fastening means are preferably constructed from one or several wires 11, which are used to attach the plants and hold the plants in position.

The passages 7-10 are preferably formed as bushings or bores which are arranged on or in the base body. Preferably, two mutually associated passages 7, 8 and 9, 10, respectively, are in, each case arranged relatively close to each other. However, they are not arranged in the same plane.

Spring clips 12 for resiliently clamping the wire 11 are arranged between each pair of mutually associated passages 7, 8 and 9, 10, respectively.

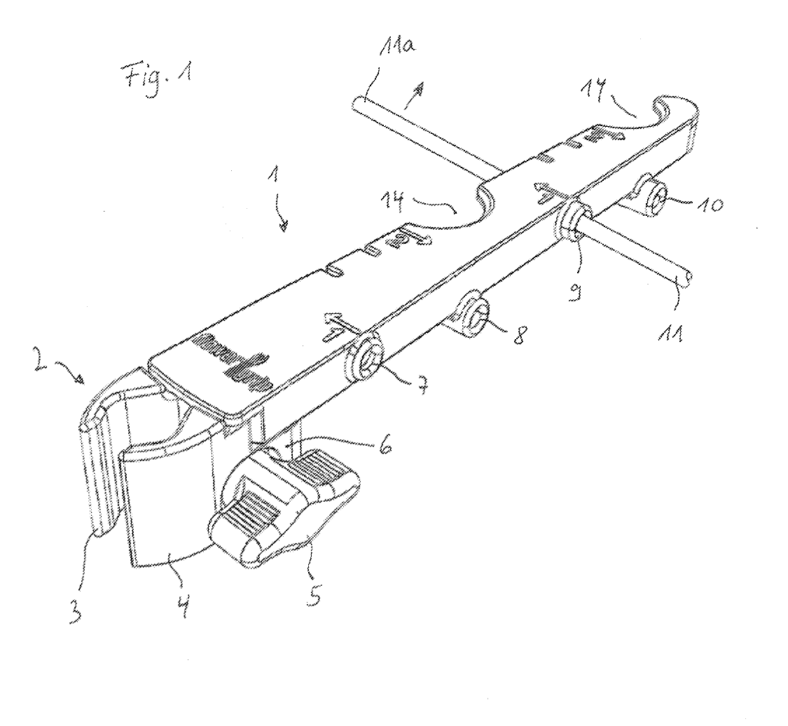

FIG. 1 shows that the wire 11 is inserted, for example, into the passage 9 from one side, with the end 11a of the wire 11 exiting the passage 9 on the other side.

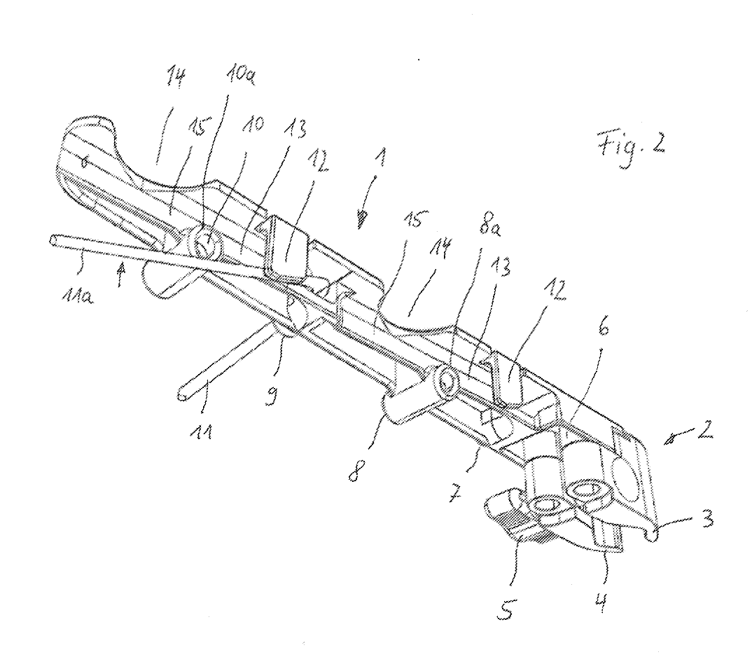

FIG. 2 shows a view of the plant holder from below. The end 11a of the wire 11 protrudes from the passage and is now bent at approximately right angles. The bent end 11a of the wire is then routed behind a spring clip 12 and brought into abutment along a guide groove 13 approximately parallel to the base body 1. The guide groove 13 extends between the passages 9 and 10 and also between the other two passages 7 and 8, wherein a respective spring clip 12 is arranged between each of the mutually associated passages 7, 8 and 9, 10. The spring clips 12 extend along the side edge of the base body 1 and are affixed at one end on the base body 1, while the other end arranged distal from the base body has an unconstrained spring action. The bent end 11a of the wire 11 is now routed behind the spring clip 12 inside the guide groove 13 and then latchingly clamped on a latching protrusion 10a of the passage 10. The inside of the spring clips 12 has a radius that facilitates latching of the wire 11. The latching protrusion 10a protrudes over the base body 1 and the guide groove 13.

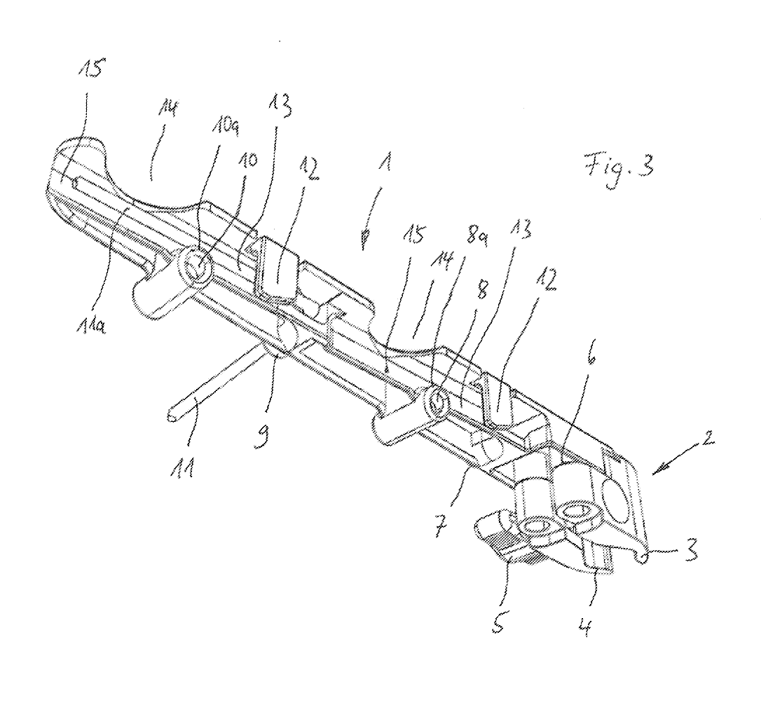

FIG. 3 shows the latched clamped position of the wire 11. The position of the wire 11 is fixed on the base body 1 in all three spatial directions. The passage 9 fixes the wire 11 in the longitudinal direction of the base body. The spring clip 12 fixes the wire 11 in the longitudinal direction of the passage 9, i.e. in the transverse direction of the base body 1. The latching protrusion 10a on the other passage 10 fixes the wire 11 so as to prevent rotation about the longitudinal direction of the passage 9, through which the wire 11 is routed.

The other end of the wire 11 beyond the first side of the passage 9 is routed around the plant to be held and back to the plant holder, where the end can then be pushed through the associated passage 10 and secured by bending the end routed through the passage 10.

Approximately thumb-sized, for example, semi-circular engagement holes 14 are disposed on the top side of the base body 1 approximately opposite and above the passages 8 and 10. The fixed wire 11 can be detached again from the latching engagement at the edge 10a by pressing with the thumb on the wire 11 on the corresponding engagement hole 14.

The abutment surface 15 for the wire 11 routed along the guide groove 13 is preferably not arranged parallel to the longitudinal axis of the base body 1, but instead extends preferably at an angle to the longitudinal axis of the base body 1 Commercially available wire is frequently bent, for example, with a diameter of 1 meter. The sloping abutment surface 15 is then better adapted to the existing curvature of the wire 11. Thus, the wire 11 can make better contact with the abutment surface 15.

In terms of applications and configurations of the plant holder, reference is made in detail to the description of EP 1815734 A2.

### LIST OF REFERENCE NUMERALS

1 Base body
2 Clamping device
3 Clamping jaw
4 Clamping jaw
5 Clamping screw
6 Clamping block
7 Passage
8 Passage
9 Passage
10 Passage
10a Locking projection
11 Wire
11a End of the wire
12 Spring clip
13 Guide groove
14 Engagement opening
15 Abutment surface

1. A plant holder with an elongated base body (1) having a plurality of passages (7-10) extending transversely to the longitudinal direction of the base body for receiving wire-shaped fastening means (11) for plants, and a clamping device (2) arranged at one end of the base body (1) for affixing the plant holder on a rod-shaped or tubular holder (11), wherein the base body (1) comprises latching protrusions (8a, 10a) associated with the passages (7, 9) for releasably attaching a bent-off end of the wire-shaped fastening means (11), with the bent-off end extending approximately parallel to the base body (1).

2. The plant holder as claimed in claim 1, wherein the latching protrusions (8a, 10a) are formed as a passage (8, 10) for receiving and guiding the wire-shaped fastening means (11).

3. The plant holder as claimed in claim 1, wherein each latching protrusion (8a, 10a) is arranged with a vertical offset in relation to the associated passage (7, 9) on the base body (1).

4. The plant holder as claimed in claim 1, wherein a spring clip (12) disposed on the base body is provided between the passage (7, 9) and the associated latching protrusion (8a, 10a).

5. Plant holder as claimed in claim 1, wherein the base body (1) comprises in the region of each latching protrusion (8a, 10a) an engagement opening (14) for releasing the wire-shaped fastening means (11) that are clamped behind the latching protrusion (8a, 10a).

6. The plant holder as claimed in claim 1, wherein the wire-shaped fastening means (11) extends along an abutment surface (15) on the base body (1), and wherein the abutment surface (15) is adapted to the shape of the bent wire-shaped fastening means (11).

7. The plant holder as claimed in claim 1, wherein he clamping device (2) is formed by adjustable clamping jaws (3, 4) that are biased by a spring force and are adjustable by means of a damping screw (5), wherein the clamping jaws (3, 4) are to be clampingly fastened on a rod-shaped or tubular holder.

8. The plant holder as claimed in claim 1, wherein each clamping jaw (3, 4) is pivotally arranged at one end on a clamping block (6) of the base body (1).
